(19) United States
(12) Patent Application Publication
(10) Pub. No.: US 2023/0115052 A1
(43) Pub. Date: Apr. 13, 2023

(54) LITHIUM BATTERY RECYCLING PROCESS, APPARATUS, AND SYSTEM FOR THE PRODUCTION OF BLACK MASS

(71) Applicant: Comstock IP Holdings LLC, Milton, GA (US)

(72) Inventors: Rahul Bobbili, San Jose, CA (US); David Winsness, Alpharetta, GA (US); Milton J. Riebel, Mankato, MN (US)

(21) Appl. No.: 17/929,491

(22) Filed: Sep. 2, 2022

Related U.S. Application Data
(60) Provisional application No. 63/240,575, filed on Sep. 3, 2021.

(51) Int. Cl. H01M 10/54; C22B 1/02; C22B 1/24; C22B 26/12

(52) U.S. Cl. CPC H01M 10/54; C22B 1/02; C22B 1/24; C22B 26/12

(57) ABSTRACT

A method of making black mass from lithium containing batterie includes the steps of closing a chamber enclosing lithium-containing batteries and injecting nitrogen into the chamber to create an atmosphere sufficiently low in oxygen to prevent explosions and burning of the lithium-containing batteries. The lithium-containing batteries are shredded in the nitrogen atmosphere to produce shredded batteries. The shredded batteries are heated in the nitrogen atmosphere to a temperature sufficient to vaporize electrolyte and plastics from the batteries and produce pyrolyzed fragments. Lithium is present in a water-soluble nitrate form within the pyrolyzed fragments. The pyrolyzed fragments are classified to produce a black mass and a remaining metals fraction. The remaining metals fraction can be further classified to recover ferrous metals, light metals, and heavy metals.

### CROSS REFERENCE TO RELATED APPLICATIONS/INCORPORATION BY REFERENCE STATEMENT

This application claims priority to U.S. Ser. No. 63/240,575 filed Sep. 3, 2021, the entire content of which is hereby expressly incorporated herein by reference.

### BACKGROUND

The present disclosure relates to recycling methods and, more particularly, to recycling methods for lithium-containing batteries.

Due to increasing demand of lithium-ion batteries (LIBs) for electric vehicles (EVs) and hybrid electric vehicles (HEV), the lithium-containing battery market, and particularly the lithium-ion battery (LIB) market is expected to grow rapidly in the next decade. Valuable metals such as cobalt, nickel and lithium are used in the cathode active materials of these batteries.

The increased demand of EVs and HEVs will lead to a significant increase in end-of-life (EOL) batteries. Therefore, there is interest in recycling the material in these EOL batteries. Traditional recycling techniques (such as pyro-metallurgy and hydro-metallurgy) use smelting or leaching processes to recover the metals; however, these traditional recycling techniques are neither environmentally friendly nor cost-effective. Improved recycling and separation of these key metals and graphite presents an economic opportunity. Additionally, improved recycling processes for LIBs can provide a significant overall reduction in greenhouse gas generation and improved decarbonization practices.

### SUMMARY OF THE DISCLOSURE

A method of making black mass from lithium containing batteries includes the steps of closing a chamber enclosing lithium-containing batteries and injecting nitrogen into the chamber to create an atmosphere sufficiently low in oxygen to prevent explosions and burning of the lithium-containing batteries. The lithium-containing batteries are shredded in the nitrogen atmosphere to produce shredded batteries. The shredded batteries are heated in the nitrogen atmosphere to a temperature sufficient to vaporize electrolyte and plastics from the batteries and produce pyrolyzed fragments. Lithium is present in a water-soluble nitrate form within the pyrolyzed fragments. The pyrolyzed fragments are classified to produce a black mass and a remaining metals fraction. The remaining metals fraction can be further classified to recover ferrous metals, light metals, and heavy metals.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 illustrates a process for recycling lithium-containing batteries in accordance with the present disclosure.

FIG. 2 illustrates a general flowchart for a lithium-containing battery recycling process in accordance with the present disclosure.

### DETAILED DESCRIPTION

Before explaining at least one embodiment of the present disclosure in detail, it is to be understood that the present disclosure is not limited in its application to the details of construction and the arrangement of the components or steps or methodologies set forth in the following description or illustrated in the drawings. The present disclosure is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the present disclosure shall have the meanings that are commonly understood by those of ordinary skill in the art. Further, unless otherwise required by context, singular terms shall include pluralities and plural terms shall include the singular.

All publications, patent applications, patents, and other references mentioned herein are incorporated by reference in their entirety.

All of the materials and/or methods disclosed herein can be made and executed without undue experimentation in light of the present disclosure. While the materials and methods of the present disclosure have been described in terms of preferred embodiments, it will be apparent to those skilled in the art that variations may be applied to the articles and/or methods and in the steps or in the sequence of steps of the method described herein without departing from the concept, spirit, and scope of the present disclosure. All such similar substitutes and modifications apparent to those skilled in the art are deemed to be within the spirit, scope, and concept of the present disclosure.

As utilized in accordance with the present disclosure, the following terms, unless otherwise indicated, shall be understood to have the following meanings:

The use of the word “a” or “an” when used in conjunction with the term “comprising” in the claims and/or the specification may mean “one”, but it is also consistent with the meaning of “one or more,” “at least one,” and “one or more than one.” The use of the term “or” in the claims is used to mean “and/or” unless explicitly indicated to refer to alternatives only or that the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

Unless otherwise indicated, all numbers expressing quantities of size (e.g., length, width, diameter, thickness), volume, mass, force, strain, stress, time, temperature or other conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

With respect to the terms “comprising,” “consisting of,” and “consisting essentially of,” where one of these three terms is used herein, the presently disclosed and claimed subject matter can include the use of either of the other two terms.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. The term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

The term “associate” as used herein will be understood to refer to the direct or indirect connection of two or more items.

The term “black mass” refers to a black powdery material typically consisting of a mixture of lithium, manganese, cobalt and nickel in different ratios and produced after removal of plastics, electrolyte, aluminum, copper and other contaminates from a lithium-containing battery.

U.S. Pat. No. 10,919,046 discloses a process, apparatus, and system for recovering materials from batteries using a grinding apparatus that grinds lithium-ion batteries wherein the battery parts are ground and submerged in a liquid comprising sodium hydroxide. The liquid provides for cooling if heat is generated and dissolves the electrolyte material from within the ground battery parts. However, the direct emersion of ground batteries into a liquid (water and sodium hydroxide) can cause a strong exothermic reaction producing highly corrosive hydrogen fluoride (HF), other dangerous gases, and can even catch fire which can deteriorate the quality of the black mass material and create numerous safety issues. Secondly, this limits downstream separation processes using hydrometallurgical processes by creating sulfates from interaction of the sodium hydroxide with the various metals during this process. The use of sodium hydroxide in a liquid in which the ground batteries are immediately submerged also provides for dissolving the electrolyte material into the liquid stream which then must be removed, further complicating the process and imparting impurities within the black mass. Further, additional steps of micro filtration and drying are required.

Unlike these prior hydrometallurgical processes, the presently disclosed process provides for a low-oxygen, dry process for autoloading, shredding and pyrolysis that does not change nor degrade the materials within the black mass nor creates sulfates that can be problematic in further processing steps to recover individual metals or materials downstream. The presently disclosed methods provide for a high purity black mass that can also be produced at higher throughputs without black mass degradation.

U.S. Pat. No. 10,522,884 discloses a method and apparatus for recycling lithium-ion batteries starting with a cathode material and further dissolving various metals within this portion. However, it does not address a front end process required to get from the battery to the cathode-only material.

Similarly, U.S. Pat. No. 9,484,606 discloses recycling and reconditioning of battery electrode material and also starts from a quantity of spent lithium nickel manganese, cobalt oxide electrode material or black mass without the graphite present.

In contrast, the present disclosure specifically deals with taking a spent or “out of spec” lithium containing battery and creating a pure form of black mass material. Secondly, the present disclosure addresses various separation processes within the primary process and apparatus that allows for higher purities with no degradation and provides for simpler downstream separation processing.

The methods and apparatus disclosed herein recycle lithium-containing batteries including, but not limited to, lithium-ion batteries (LIB's). Lithium-containing batteries include, but are not limited to, lithium-ion, lithium nickel manganese cobalt oxide, lithium iron phosphate, lithium nickel cobalt aluminum oxide, lithium titanate and other forms of lithium containing batteries. Lithium-ion batteries (LIB's) can comprise a number of additional materials including, but not limited to plastics, electrolyte polymers, metals, graphite, and other materials based on the battery type and makeup. While the presently disclosed processes are discussed in terms of lithium-ion batteries, it is understood that the presently disclosed steps and equipment can also be used to treat other lithium-containing batteries.

Materials present in rechargeable lithium-ion batteries include organics such as alkyl carbonates (e.g. C1-C6 alkyl carbonates, such as ethylene carbonate (EC), ethyl methyl carbonate (EMC), dimethyl carbonate (DMC), diethyl carbonate (DEC), propylene carbonate (PC), and mixtures thereof), iron, aluminum, copper, plastics, graphite, cobalt, nickel, manganese, and of course lithium. Recovering such materials from rechargeable lithium-ion batteries is highly desirable.

Typically, lithium-ion battery cells have four key components: a positive electrode or cathode; a negative electrode or anode; electrolyte; and a separator between the anode and cathode. The positive electrode or cathode can comprise differing formulations of lithium metal oxides and lithium iron phosphate depending on battery application and manufacturer, intercalated on a cathode backing foil/current collector (e.g. aluminum)—for example: LiNixMnyCozO2 (NMC); LiCoO2 (LCO); LiFePO4 (LFP); LiMn2O4 (LMO); LiNi0.8Co0.15Al0.05O2 (NCA). The negative electrode or and generally comprises graphite intercalated on an anode backing foil/current collector (e.g. copper). Electrolyte can include, for example, lithium hexafluorophosphate (LiPF6), lithium tetrafluoroborate (LiBF4), lithium perchlorate (LiClO4), lithium hexafluoroarsenate monohydrate (LiAsF6), lithium trifluoromethanesulfonate (LiCF3SO3), lithium bis(bistrifluoromethanesulphonyl) (LiTFSI), lithium organoborates, or lithium fluoroalkylphosphates dissolved in an organic solvent (e.g., mixtures of alkyl carbonates, e.g. C1-C6 alkyl carbonates such as ethylene carbonate (EC, generally required as part of the mixture for sufficient negative electrode/anode passivation), ethyl methyl carbonate (EMC), dimethyl carbonate (DMC), diethyl carbonate (DEC), propylene carbonate (PC)). The separator between the cathode and anode can be, for example, polymer or ceramic based.

The LIB material may also include various plastics, packaging, wire, and other various packaging and functional materials. Thus, rechargeable lithium-ion batteries comprise a number of different materials. The term “black mass” refers to a combination of cathode and/or anode electrode powders comprising lithium metal oxides and lithium iron phosphate (cathode) and graphite (anode), as referenced above. One can see that for separation steps to efficiently isolate the individual metals and materials, it is important that the black mass components are not degraded nor additional impurities added.

For example, a portion of the black mass material derived from the cathode within a battery that can comprise approximately 4% nickel, 5% Mn, 8% cobalt, 7-8% lithium carbonate or lithium carbonate equivalent, 10% copper, 15% aluminum, 16% graphite plus additional materials. These components (i.e., cobalt, lithium, copper, graphite, nickel, aluminum, and manganese) can represent approximately 90% of the residual value of the battery.

It is known that simple grinding of lithium batteries with a charge remaining can create an extremely exothermic reaction sufficient to start fires or explode, generating noxious gas vapor. Various attempts have been made to solve this key issue. Discharging each individual battery is currently one method, but requires significant labor costs and time. In addition, some LIB's are difficult to fully discharge, thus leaving energy still stored in the battery that can lead to exothermic reactions.

Some recycling methods use grinders that are immersed in a liquid such as water or blends of water with sodium hydroxide. Although this helps retard the exothermic reaction and prevent fires, this can have an adverse effect on the overall quality of the final black mass product by degradation and addition of impurities. Furthermore, this approach converts the lithium and other materials into sulfate products which is problematic for downstream process.

In contrast, the presently disclosed process uses a series of flow chambers with a nitrogen atmosphere to accomplish size reduction, thermosetting, and vaporization of electrolyte and plastics. The resulting cooled material is inert and can be safely classified to separate black mass powder, and further classified using screens and magnetic separators. Each of these steps is discussed in detail below.

In one embodiment, a flow chamber or series of flow chambers with a very low oxygen-containing nitrogen atmosphere is utilized. The flow chambers can be used for loading, grinding, and electrolyte vaporization of LIB's using a sealed containment design. This retards the exothermic reaction and/or reduces the risk of fire and excess heat generation. This then allows for higher throughput and yields a high purity black mass product for further downstream processing. For example, three chambers can be operated in series with continuous nitrogen gas flow and low oxygen levels: a gated loading chamber, a first multi-shaft shredding chamber, and a second multi-shaft shredding chamber, in addition to a sealed continuous pyrolysis oven system. The ability to flow nitrogen gas through this integrated sealed system provides a significant advantage for throughput and efficiency while maintaining a safe operational environment. In addition, and as discussed in detail hereinafter, the nitrogen can react with lithium in the pyrolysis oven to form a water-soluble nitrate which is easily recovered.

In one embodiment, the presently disclosed process provides a continuous sealed oven and cooling section wherein the ground battery material or fragments are directly dropped into a cylindrical continuous heating oven having a slow rotation paddle system to move the material through this section. The oven operates at a temperature sufficient to vaporize the polymeric components of the electrolyte and render the battery material inert and stable. The continuous oven is also under a low oxygen environment with nitrogen flow coming from the above grinding systems.

In one embodiment, the presently disclosed process includes a continuous cooling system at the output of the continuous oven. The cooling system cools the material to a reasonable temperature for handling and further processing.

In one embodiment, the presently disclosed process includes a system to collect the vapors from vaporization of the electrolyte portion, wherein the vapors are further condensed and collected.

In one embodiment, a buffer screw storage system feeds cooled material into a multi-deck screening system for a first classification step, producing a primary back mass product and a second stream for further processing. The second stream can be fed to a second classification system integrating screen separation, magnetic separation and air separation to break down the various portions of the inert battery material into a high-quality black mass and other metal product streams for recycling.

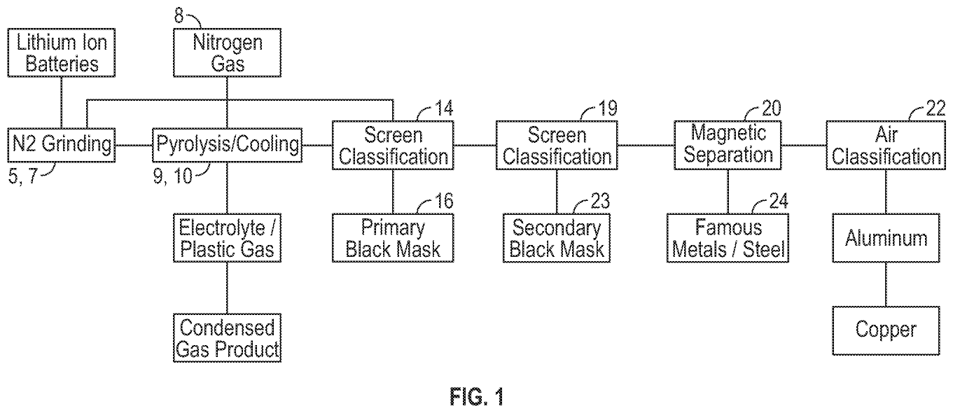

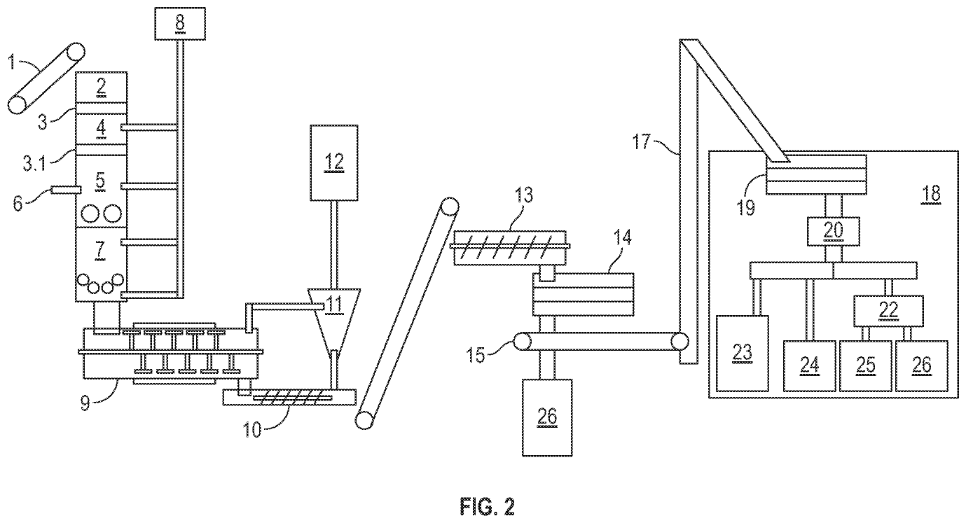

Referring now to FIG. 1 and FIG. 2, in one embodiment batteries are loaded onto a conveyor feeding system 1 to provide a controllable feed rate. A loading hopper 2 is used with an integrated slide gate valve 3 to hold a specific number, weight, or volume of batteries and to prevent the release of nitrogen gas from the system. The batteries are then dropped into a sealed chamber system 4 comprising gates 3 and 3′. The sealed chamber is filled with nitrogen gas from a nitrogen generator 8. Once oxygen has been displaced by nitrogen (controlled by an oxygen sensor 6) the gate valve 3′ is opened sending batteries into a primary coarse grinding system 5. The course grinding system 5 is also in a reduced oxygen atmosphere provided by a nitrogen generator 8. The course ground material is then directly sent by gravity to a finer grinding system 7. Grinding stages 5 and 7 can include a multi-shaft shredder similar to one provided by SSI Shredding Systems (SSI World).

The ground battery material size at this point within the system can range from less than ¼″ to over 1″ or 2″ in size and more. In one embodiment the material size is approximately 1″ in length by various widths based on the types of batteries. The ground battery material can then be directly sent to a continuous heating oven 9 wherein the battery material is subjected to heats of, for example, 500° C. to 550° C. Heat can actually range from 250° C. to 600° C. At the 500° C. to 550° C. temperature range, the polymer portion of the electrolyte is vaporized and the remaining electrolyte is thermoset to a solid pyrolysis fragment material. The vaporized gas phase flows through a cyclone 11 and then to a heavy scrubber 12 wherein the vapor is condensed.

The solid pyrolysis fragments from the continuous heat oven 9 can then flow directly into a continuous cooling section 10 to cool the fragments to a reasonable handling temperature. In one embodiment, the continuous cooling apparatus is made from a tube and screw or series of paddles that moves the material through the tube and wherein the tube and optional screw/paddle shaft can also be cooled using chilled water. The cooled material can then be sent by conveyor to a holding screw conveyor 13 from which samples can be taken for quality control or batch separation.

In one embodiment, the input gate apparatus, the multi-step grinding apparatus and the continuous pyrolysis oven apparatus are all sealed together and are provided with a nitrogen flow from the nitrogen generator 8 to the gated chamber as needed and continuously to the first and second shredder. The nitrogen flows from the shredding chambers 5 and 7 directly into the pyrolysis oven 9 and exits through the cyclone 11 and to the condensing apparatus 12. The material can then be fed to a first classification screener 14 which provides at least two material outputs. The first output is a primary black mass 16. The second material typically comprises a blend of metals and graphite materials and can be fed by, for example, a vertical conveyor 17, to a multi-step classification system 18.

The multi-step system 18 integrates a multi-screen mechanical classifier 19 and a magnetic separation subsystem 20. The screening system provides additional action on the material to release any additional black mass. Fine secondary black mass then flows to a storage bin 23 and the remaining screened fraction moves to a magnetic separation subsystem 20. From the magnetic separation, the ferrous metals or steel used in the LIB flows into a container 24 and the nonferrous metals move to an air density separator 22 which sorts the lighter metals 25 from the heavier metals 26. These metals primarily consist of aluminum and copper. Thus, final products can then be stored in various containers (16, 23, 24, 25, 26) for warehousing and the black mass can be sold or further processed to separate out the individual valued materials.

In an example process for recycling lithium-containing batteries, loading and delivery of the battery material is accomplished with a metering conveyor that conveys to a feed chute which is blocked by an automatic actuated slide gate. Upon reaching a specific weight, the slide gate opens into an air lock chamber which comprises an upper gate and a lower floor gate to create a sealed chamber for a specific size or weight batch. Oxygen is removed from the chamber by displacement using nitrogen gas. Once fully purged of oxygen, the bottom floor gate opens into the shredding/pyrolysis section of the apparatus.

In another embodiment, the shredding section comprises two shredding sections that are sealed and nitrogen gas flows enters into this portion of the system and exits from the continuous pyrolysis oven section. A range of shredding systems can be used including, but not limited to, hammer mills, granulators, jaw crushers, cone crushers or roll crushers. One embodiment utilizes a multi-shaft shredder. Multi-shaft shredders are top fed by gravity into sharp or semi-sharp sets of intermeshing disc knifes. Such shredders can have twin shafts or quad shaft configurations. The shafts rotate toward each other pulling material through the center to shred the battery materials into fragments. One advantage of such shredders is that they require less energy and easily pull non-uniform battery shapes through the shredding system to produce uniform fragments.

In one embodiment, a twin shaft shredder is stacked on top of a quad shaft shredder and nitrogen gas flows through this system at a constant rate to remove heat, prevent fires, and retard the exothermic reactions.

The exit of the shredder system can be a sealed chute that optionally contains a thermal break gasket in which the fragments are gravity dropped into a cylindrical continuous feed pyrolysis oven. The oven's primary objectives are to heat the fragments to a temperature of approximately 500° C. to 550° C. to thermoset the fragments and vaporize the polymeric portion of the electrolyte material, thus rendering the material inert to oxidation, and to convert at least a portion of the lithium to a water-soluble nitrate form while leaving other metals as water-insoluble oxides. In one embodiment, the pyrolysis oven can integrate a paddle conveying system to slowly pass through the oven. In another embodiment, the oven has various heating zones to allow for a ramp of temperature to the target vaporization temperature. Within the continuous pyrolysis oven, two exit ports can be integrated in which one provides for the exit of vapors and fine airborne dust into a cyclone section. The cyclone section then proceeds to a condensation system to condense the vapors. This system optionally includes a thermal oxidizer for any residual vapor. The second exit from the continuous pyrolysis oven allows for the exit of the solid fragments directly into a cooling section such as a continuous cylindrical cooling section. Various sealed cooling systems can be used such as a screw or paddle system with an exterior cooling wrap and optional water-cooled shaft. The continuous cooling simply reduces the temperatures to a reasonable temperature for further processing. In one embodiment, the solid inert fragments enter a batch vessel with automatic unloading. This allows for quality control by batch throughout the balance of the process. The exit of the batch vessel then is conveyed to the multiscreen classifier 19.

Metals typically found in the active portion of a lithium-ion battery are in the form of various metal oxides. The metal oxides can include cobalt, nickel, manganese, and iron. Problematically, the metal oxides are typically sintered with lithium, thus the lithium and the metals are in the form of an oxide and are not water soluble and cannot be extracted by aqueous leaching. Further, prior art separation of lithium from the valued metal oxides requires many process steps and chemistries in hydrometallurgy processes in which the lithium is typically the last material recovered. The lithium recovered from LIB's at the end of hydrometallurgical processes typically is of a lower grade with various impurities, and is thus not able to be directly recycled into LIB's by the battery manufacture.

Prior art black mass, such as that resulting from grinding under water and drying, comprises both insoluble metal oxides and a substantial percentage by weight of graphite. Such black mass is secondarily processed using either pyrometallurgical or hydrometallurgical processes to extract and separate the valued metals, primarily cobalt nickel and manganese. Because these processes are complicated and costly, some types of LIB's such as lithium iron phosphate batteries are typically not recycled because they lack valued metals and are uneconomical to process. However, the present disclosure allows for economic recovery of lithium, from even lithium iron phosphate batteries, by forming a black mass with water-soluble lithium nitrate and other metals remaining as oxides and water-insoluble.

As previously described, at the beginning of the presently disclosed processes, spent LIB's are crushed, baked and cooled under a continuous nitrogen addition environment in which batteries can have various degrees of charge or stored energy. The baking can be from 200° C. to 550° C. and processing under this heated condition for between 2 minutes to 60 minutes in a continuous heating system with nitrogen flow though. Although this disclosure teaches of processing various types of LIB's, in one embodiment LFP batteries are shredded and conveyed into a heated nitrogen environment. As the temperature ramps to approximately 100° C., the solid electrolyte interphase (SEI) layer starts to go through thermal degradation and provide oxygen to the mixture. At 200° C., the active material or lithium iron phosphate start to produce oxygen within its thermal runaway range, typically from 200° C. to 250° C. The nitrogen and slight addition of oxygen then provides for the conversion of the metal oxides to nitrates. Nitrates are soluble in water. As temperature and time increase to temperatures above this range, the iron and nickel nitrates are converted back to oxides while the lithium nitrate stays in the nitrate form because its thermal decomposition temperature is above 600° C. Thus, the only remaining water-soluble material is lithium at this point.

The resulting black mass, sometimes referred to hereinafter as nitrogen pyrolyzed black mass (or NP black mass) comprises water soluble lithium nitrate, water insoluble iron, water insoluble nickel oxides (if nickel is present in the LFP), and graphite. During heating to the 450° C. range, we also see a degradation of the various plastics including various plastic separator materials, various packaging material and a portion of the PVDF fluoropolymer binder within the black mass material.

In one embodiment, the metallic components in Li-ion battery waste are firstly transformed into corresponding nitrates using a gaseous nitrogen process. Using self-generated oxygen from the battery materials in the heating process, they are then decomposed into insoluble oxides during baking - except for lithium nitrate, which is ready to be extracted by water leaching or can be extracted using phase a separation process wherein both the lithium and graphite can be fractionated and recovered. In some embodiments, the water leaching of lithium uses high shear.

Thus, after the conversion within the nitrogen heat environment and taking advantage of the release of oxygen within the battery material as heat increases, most of the constituent elements in LIB scrap are transformed into their corresponding nitrates; these can then be easily decomposed into insoluble oxides at the appropriate roasting temperatures (<300° C.) with the exception of lithium nitrates. It is well known that most nitrates readily decompose at low temperatures, for example, Al(NO₃)₃ at 125-175° C., Cu(NO₃)₂ at 150-225° C., Co(NO₃)₂ at 150-225° C., and Ni(NO₃)₂ at 150-250° C., whilst in contrast, LiNO₃ has a decomposition temperature of 600° C.

Thus, by using a nitrogen atmosphere rather than liquids for grinding and pyrolysis of LIB's, we can maintain a higher purity of black mass material compared to prior art methods. Further, the lithium becomes soluble in water and readily separated from the remaining metals and NP black mass.

In the following examples, specific experimental methods are described. However, the present disclosure is not limited in its application to the specific experimentation, results and laboratory procedures. Rather, the Examples are simply provided as one of various embodiments and are meant to be exemplary, not exhaustive.

### EXAMPLES

### Example 1

Lithium-ion batteries were purchased at a local store and divided into three groups. Group I was discharged to a very low power level. Group II was discharged to approximately 50% of its stored energy and Group III was left fully charged. Using an enclosed metal chamber with a Plexiglas™ safety window for viewing, the batteries from each group were punctured or cut using hand tools. As expected, the batteries that were partially or fully discharged did not react, or in some cases had a very minimum release of vapor and heat. The fully charged batteries, when cut, quickly went into an exothermic reaction creating massive smoke vapors, sparking, and in one case caught on fire.

Additional new batteries from Groups I, II, and III were then tested wherein the metal chamber was filled with nitrogen on a continuous basis. We noticed a substantial difference with lower smoke vapor generation and no “sparking” during the exothermic reaction of the batteries with higher remaining charge levels.

Additional batteries were tested as follows:

A. PKCELL™ Li-ion 3.7V 350 mAh—Cutting under nitrogen flow showed minimal reaction, occasionally some bubbling and white smoke, but no sparking or high heat generation.

B. Infant Optics™ Li-ion 3.7V 1200 mAh—Cutting under nitrogen flow had minimal reaction with some bubbling and occasionally very small amounts of white vapor.

C. PKCELL™ Li-ion Pack (3 cell) 3.7 V—Cutting under nitrogen flow caused a quick burst, but then very quickly stabilized.

From this set of experiments, we saw significant differences when cutting or puncturing with or without the presents of oxygen and that the nitrogen flow reduced the bubbling and vapor release. In addition, we saw less heat generation and no “sparking” of the layers within the fragments.

### Example 2

New and recycled lithium containing batteries were obtained that included rechargeable and non-rechargeable lithium batteries. Within these groups we had a blend of batteries having different charge levels from fully charged to partially discharged. We retrofitted a Retsch™ granulator grinding system with a spiral cutter head operating at approximately 1,000 RPM. Nitrogen fittings were installed as to provide a continuous flow of nitrogen within the cutting chamber and exit. The exit was sealed with a vessel to capture the ground fragments.

Various types of lithium-ion batteries were injected and ground into fragments. To our surprise, we saw very little smoke and little increase in internal temperatures. The material fragments were very uniform.

### Example 3

The remaining fragments from Examples 1 and 2 were examined in which we noticed that some of the fragments had a “oil like” substance on various fragments. This was assumed to be a portion of the electrolyte material. In handing the fragments we noticed that the “NP black mass” powder was stuck onto the aluminum and copper foil fragments and was difficult to remove even with tools or simple scraping.

### Example 4

Untouched used lithium-ion batteries were placed in a metallurgical oven that was equipped to flow nitrogen into the oven. The initial temperature set point was 150° C. At close to this temperature, we saw a lot of white smoke being generated and the temperature of the oven quickly increased to 250° C. because of the exothermic reaction. After two hours, the oven temperature came back to the set point of 150° C. The oven then was ramped to 550° C. at a rate about 10° C./minute until temperature was reached. Smoke continued to be exhausted from the exit port for approximately 45 minutes. After this period of time, the white smoke vapors quit.

### Example 5

The fragments that were cut under nitrogen environment or very low oxygen environment where then placed into a metallurgical oven that also was retrofitted to provide for continuous nitrogen flow into the oven during this test. The temperature was ramped from room temperature to a temperature of 500° C. The vapor released from the exhaust port was observed. Significantly less white smoke was observed.

### Example 6

Fragments from Example 5 were inspected in which some of the larger pieces required cutting open to access all of the material. The “black powder” or black mass material easily fell off of the copper and aluminum foils. The film fragments were then stirred to allow for rubbing of the foils together. This provided more of the black mass material to release from the foils. After separating the materials, including aluminum casing, copper and aluminum foils, and black mass, we found the following results in weight percentages:

| | |
|---|---|
| 20% | Casing (aluminum) |
| 30% | Copper and Aluminum from films |
| 50% | Black Mass |

### Example 7

Lithium-ion battery cells from a Tesla™ EV pack (Tesla™ 18650B) were separated into individual cells. The cells were shredded using a knife shredder (Retsch™ Lab Cutter) having a high flow of nitrogen. The shredded material was then placed into a metallurgical oven with nitrogen flow and heated to 450° C. for one hour. The material was let to cool also under a nitrogen environment. The material was screened using a 40-mesh screen in which the NP black mass flowed through the screen and the overs represented a mixture of scrap metals and carbonized plastic pieces. ICP testing was done on the black mass fraction wherein it comprised 3.33% elemental lithium, 22% elemental nickel, 4.7% elemental cobalt and 0.6% elemental aluminum.

The black mass was then placed in water at a ratio of 10;1 and stirred for 10 minutes. The material was then filtered to separate out the insoluble materials of metal oxides and graphite leaving the remaining water. The water fraction was then evaporated in a hot plate. To our surprise, we did not see any precipitation until most all water was boiled off showing a high degree of solubility of the lithium greater than 50 g/ 100 mg. Given all other forms of common lithium (oxides, carbonates) have a much lower solubility in water, we should have seen precipitation of the lithium soon after the initial heating with minimal water removal. (Lithium oxide 12 g/100 mL, Lithium carbonate 1 g/100 mL).

The rest of the water was evaporated and the remaining solids were white. Based on the conversion from elemental lithium to lithium nitrate, we found that the estimated mass balance matched between the elemental lithium of the black mass and the residual white powder left over by mass. The white material was then run through ICP showing that the material comprised elemental lithium.

### Example 8

The objective in this example was to better understand the smoke and heat generation during shredding and pyrolysis. In a simple test, two partially charged LIB's were cut open in which one was cut in a normal atmospheric environment and the second one under nitrogen gas flow. We clearly observed significantly less heat and smoke when cutting under a nitrogen gas. We then took ground fragments of LIB's from previous grinding tests. The material was placed into an oven with continuous nitrogen flow into the oven, starting to ramp in temperature to 150° C. At this temperature the electrolyte material appeared to vaporize. Little to no smoke and constant heat was observed. During the test, the nitrogen tank ran out of nitrogen and to our surprise, significant smoke was generated through the vent exit of the oven and the temperature spiked by approximately 100° C. After changing nitrogen tanks and restarting the nitrogen flow, the process temperature was reduced and the smoke was significantly reduced to little or no smoke being exhausted.

### Example 9

An apparatus for recycling lithium-containing batteries and producing black mass, comprises a metering system, a gated sealed chamber, a two-step shredding system, a pyrolysis oven, a cooling device, a vapor recovery system, a storage vessel, and a screen classification system. The metering system loads batteries and conveys batteries to a hopper. The gated sealed chamber includes nitrogen gas input to batch load a continuous two-step shredding system. The two-step shredding system is sealed with nitrogen flow integration and shreds the batteries into fragments to liberate various materials. The pyrolysis oven is a continuous fragment flow sealed pyrolysis oven directly coupled to the shredding system to vaporize electrolyte and pyrolyze remaining fragments. The pyrolysis oven receives nitrogen flowing from the shredding system. The vapor recovery system includes a condensation apparatus for recovery of vaporized electrolyte. Pyrolyzed fragments are cooled in a continuous flow cooling device and stored in a batch storage vessel having the ability to meter out material to a first mechanical screen classification system to produce primary or NP black mass from the cooled fragments. The multi-classification system comprising mechanical screening, magnetic separation, and air classification to separate a secondary black mass powder, magnetic metals, and non-magnetic metals from the cooled screened fragments.

### Example 10

Six lithium-ion battery types were acquired comprising lithium titanate (LTO), lithium nickel cobalt aluminum oxide (NCA), lithium iron phosphate (LFP), lithium nickel manganese cobalt oxide (NMC), lithium cobalt oxide (LCO), and lithium manganese oxide (LMO). The separate types of batteries were each ground using a knife shredder under a continuous nitrogen flow. The resulting material was then baked at a temperature of 450° C. for 2 minutes also under continuous nitrogen flow. The materials were then screened using a 60-mesh screen in which the <60 mesh was our black mass samples.

Each black mass sample from each battery type was split to create a retention sample and a process sample for lithium solubility. Each of the six process samples where then split into three groups for extraction. The three extraction methods were room temperature water (25° C.) and mixed for 180 minutes in an open beaker with a ratio 45:1 of water to black mass material (Sample I). The second method increased the temperature from 25° C. to 90° C. (Sample 2). The third method used a Parr reactor wherein temperature was further increased to 260° C. and pressurized to 1300 psi using a CO₂ blanket (Sample 3).

Samples 1, 2, and 3 were all filtered to remove the solids (Grey Mass) leaving an aqueous mixture with dissolved lithium.

The six black mass samples representing each battery type retention material and the six “grey mass” samples were then digested using a microwave assisted acid digestion, with nitric acid and hydrochloric acid according to method reference EPA 3051A 2007.

The 12 samples were then subjected to ICP-OES elemental analysis (method Ref: EPA 6010B 1996). Data was collected based on the starting lithium percentage in each black mass sample and lithium percentage in the processed grey mass as follows in Tables 1-3.

TABLE 1
Sample Group 1 (rm. temp., 25°
C., 180 min, 45:1 ratio, atm. press.)

| | Black Mass | Grey Mass | Lithium |
|---|---|---|---|
| | Lithium % | Lithium % | Solubility % |
| LTO | 4.18 | 3.17 | 23.16 |
| NCA | 3.88 | 1.27 | 67.27 |
| LFP | 1.97 | 1.5 | 23.35 |
| NMC | 3.85 | 1.69 | 56.1 |
| LCO | 3.31 | 1.45 | 56.19 |
| LMO | 2.33 | 1.68 | 72.0 |

TABLE 2
Sample Group 2 Comparison test with increased temperature
(90° C., 180 min, 45:1 ratio, atm. press.)

| | Black Mass | Grey Mass | Lithium |
|---|---|---|---|
| | Lithium % | Lithium % | Solubility % |
| LTO | 4.18 | 2.57 | 38.52 |
| NCA | 3.88 | .92 | 76.26 |
| LFP | 1.97 | .46 | 24.37 |
| NMC | 3.85 | 1.32 | 65.71 |
| LCO | 3.31 | 1.12 | 66.16 |
| LMO | 2.33 | 2.14 | 92.02 |

TABLE 3
Sample Group 3 Comparison test using supercritical CO₂ (260°
C. with CO₂ addition, 180 min, 45:1 ratio, 1300 psi pressure)

| | Black Mass | Grey Mass | Lithium |
|---|---|---|---|
| | Lithium % | Lithium % | Solubility % |
| LTO | 4.18 | 1.29 | 38.52 |
| NCA | 3.88 | .92 | 76.26 |
| LFP | 1.97 | 1.45 | 26.4 |
| NMC | 3.85 | .44 | 88.57 |
| LCO | 3.31 | .92 | 72.33 |
| LMO | 2.33 | .14 | 94.12 |

### CONCLUSION

Thus, in accordance with the present disclosure, there has been provided methods, processes and systems that fully satisfy the objectives and advantages set forth herein above. Although the present disclosure has been described in conjunction with the specific language set forth herein above, it is evident that many alternatives, modifications, and variations will be apparent to those skilled in the art. Accordingly, it is intended to embrace all such alternatives, modifications, and variations that fall within the spirit and broad scope of the present disclosure. Changes may be made in the construction and the operation of the various components, elements, and assemblies described herein, as well as in the steps or the sequence of steps of the methods described herein, without departing from the spirit and scope of the present disclosure. Furthermore, the advantages described above are not necessarily the only advantages of the present disclosure, and it is not necessarily expected that all of the described advantages will be achieved with every embodiment of the presently disclosure.

What is claimed is:

1. A method of making black mass from lithium containing batteries, comprising the following steps:
closing a chamber enclosing lithium-containing batteries and injecting nitrogen into the chamber to create an atmosphere sufficiently low in oxygen to prevent explosions and burning of the lithium-containing batteries;
shredding the lithium-containing batteries in the nitrogen atmosphere to produce shredded batteries;
heating the shredded batteries in the nitrogen atmosphere to a temperature sufficient to vaporize the electrolyte and plastics and produce pyrolyzed fragments with lithium in a nitrate form;
classifying the pyrolyzed fragments to produce a black mass and a remaining metal fraction; and
further classifying the remaining metal fraction to recover ferrous metals.

2. The method of claim 1, wherein the shredding, heating, and classifying steps are continuous.

3. The method of claim 1, wherein the shredded batteries are heated to a temperature in the range of about 150° C. to about 500° C.

4. The method of claim 1, further comprising the step of cooling the pyrolyzed fragments in the nitrogen atmosphere.

5. The method of claim 4, wherein the cooled pyrolyzed fragments are classified using a screen classifier to produce the black mass and the remaining fraction.

6. The method of claim 1, wherein the step of further classifying the remaining metal fraction comprises a multi-step classification process integrating mechanical screening, magnetic separation, and air classification, wherein the mechanical screening removes black mass fines, the magnetic separation collects ferrous metals, and the air classification separates remaining lighter materials from heavier materials.

7. The black mass produced by the process of claim 1.

8. A system comprising battery shredding and pyrolysis operations, the battery shredding and pyrolysis operations conducted within a nitrogen atmosphere.

9. A continuous flow shredder and pyrolysis oven, the shredder and pyrolysis oven integrating a continuous nitrogen gas flow to create a low oxygen environment.

10. A pyrolysis method comprising oven vaporization of electrolytes and plastics from lithium-containing batteries, the vaporization conducted in a nitrogen atmosphere.

11. A black mass produced using the meth of claim 1, the black mass free of electrolyte and comprising water soluble Li nitrates.

12. The black mass of claim 11, further comprising metal oxides insoluble in water.

13. The black mass of claim 12, wherein the metal oxides are selected from the group consisting of Co, Ni, Fe, Mn, Ti, Al and combinations thereof.

14. The black mass of claim 11, further comprising graphite.
